(19) United States
(12) Patent Application Publication
(10) Pub. No.: US 2010/0275458 A1
(43) Pub. Date: Nov. 4, 2010

(54) STORAGE DEVICE

(76) Inventor: Jason Saunders, Surrey (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/733,558

(22) PCT Filed: Apr. 9, 2008
(86) PCT No.: PCT/GB2008/002985

§ 371 Date: Jun. 24, 2010

(30) Foreign Application Priority Data
Sep. 11, 2007 (GB) 0717742.1

(51) Int. Cl. F26B 5/16

(52) U.S. Cl. 34/353; 34/95

(57) ABSTRACT

The invention relates to a storage device (1), and more specifically to a device (1) for storing and drying articles, in particular tennis balls (4), to maintain their performance and preserve their longevity. The device (1) comprises a layer (6) of a wicking material, and the drying of articles is achieved through direct contact of the wicking material with the articles to be dried.

The invention relates to a storage device. More specifically, but not exclusively, the invention relates to a device for storing and drying articles such as balls, specifically tennis balls, to maintain their performance and preserve their longevity.

Tennis balls are made of an inflated and pressurised rubber compound ball, covered in wool and/or synthetic fibres. The balls are typically supplied to the consumer in pressurised metal containers. Once released from these containers, the balls begin to lose their inner pressure due to the permeable rubber compound ball, which allows the pressurised gas to slowly escape over time.

Tennis balls also lose significant performance when exposed to moisture. Water is absorbed into the wool or synthetic fibre surface and is retained until it naturally evaporates. Once a tennis ball is wet, the covering fibres begin to expand and the ball becomes heavier. With the expanded tennis ball fibres full of moisture, the size of the ball increases affecting its aerodynamic qualities. The added weight also contributes to a reduced bounce height compared with a dry ball. This makes playing tennis to any reasonable standard prohibitive due to constant adjustment in stroke play to accommodate bad bounces and slower ball movement though the air. Nonetheless, tennis players throughout the world play tennis on outdoor courts in varying climate conditions. These tennis courts are exposed to precipitation and surface moisture from rain, dew and frost, all of which can dramatically affect how tennis balls perform during play.

Furthermore, when a session of tennis is completed, the balls are typically placed back into the originally supplied metal container and sealed with a plastic cap in a now unpressurised but air tight condition. The wet balls will normally remain in this container until the next session of tennis, which may not be for several days or weeks. When the balls are eventually removed from the can they will often have retained significant moisture as evaporation can only have occurred at a very slow rate with no ventilation other than the permeable plastic lid on the container. This has two significant disadvantages. Firstly, the wet tennis balls will suffer the same diminished performance when next used. Secondly, the moisture that is present in the balls during the prolonged storage period can have a further detrimental effect on the integrity and lifespan of the balls.

By drying tennis balls after playing in wet conditions, the problems described above can be minimised. The tennis balls will retain more bounce ability and their useful like will be greatly increased. However, it is inconvenient to have to remove the balls from their containers, dry them out, and then replace them in their containers ready for the next session of tennis. This inconvenience means that tennis balls are commonly not dried out between sessions. It would be beneficial if a storage device existed which allowed, or preferably assisted in, the drying of tennis balls between sessions of play.

It is known to provide containers for tennis balls which incorporate hygroscopic materials such as calcium chloride, silica gel or the like, to draw moisture out of the tennis balls during storage. Such systems have, however, proved ineffective. The balls are placed in a sealed container with a separately contained quantity of hygroscopic material which withdraws moisture from the air contained in the container. Accordingly, the drying process is relatively slow, and the tennis balls spend a prolonged period in a moisture rich environment.

It is an aim of the present invention to provide a more efficient storage and drying system for wet articles, in particular for tennis balls.

According to the present invention there is provided a device for storing and drying one or more articles, the device comprising a layer of a wicking material and means for permitting direct contact of the wicking material with the or each article to be dried.

The device is of particular use for the drying of wet tennis balls, but may also be adapted for drying other sporting equipment or wet articles in general.

Through use of the device, water can be extracted from articles through means of one or more of wicking, absorption and evaporation.

Preferably, the device will also allow for easy transportation of the articles being dried, perhaps by way of an extendable handle or strap for placement over a shoulder, in a hand or in a tennis racquet bag.

The device may comprise a tube or bag of fabric, preferably with draw cords to close the or each open end, and ideally to tighten the fabric around the articles contained therein. By constricting the fabric tightly to the articles contained in the device, the maximum possible contact between the device and the articles can be achieved. The constriction can also help to squeeze further moisture out of the articles contained in the storage device. In the case of drying tennis balls, the compression achieved can also help the covering fibres to partially reset to their original position. The draw cord may comprise a length of Nylon webbing or similar, and may double as the extendable handle described above. Additionally, or alternatively, the draw cord may serve a further purpose such as, in the case of a drying device for tennis balls, a net height measure.

It is beneficial if multiple, for example three, layers of material are used in constructing the device. Where multiple layers are used, the inner most layer should provide the wicking process to extract moisture from the surface or the articles contained in the device. Suitable wicking materials include, but are not limited to, Olifin, DRYflo® and Wonder Wick®. Additional layers outside the wicking layer should have an absorptive property to hold the water until evaporation occurs. Absorptive materials such as Wool (alone or in combination with silk), Polypropylene, Fleece, Cotton, Coolmax® and Lumiza Acrylic are all suitable, as are numerous others. The combination of the wicking action of the first layer, and the absorptive property of the second layer means that moisture is quickly removed from an item being dried and retained where it is no longer in contact with the item. Certain materials, such as Wonder Wick® incorporate a dual wicking and absorption function, and it may be possible to combine the actions of the first and second layer by using a material of this type.

Preferably, the device is additionally provided with an outer layer to serve as a protective cover for the device, while also allowing the necessary ventilation and evaporation of moisture. The outer layer is preferably made from a weatherproof yet breathable material such as, for example, GORE-TEX® or SympaTex®. In use, the three layer system works as follows. The wicking layer is made to contact the wet item such that moisture is wicked from the item to the next outer absorption layer where, over time, it then evaporates and escapes through the permeable outer layer which also provides protection from further external moisture.

According to a second aspect of the present invention there is provided a method of storing and drying one or more articles comprising the steps of placing the or each article to be dried into a device comprising a layer of a wicking material, and causing the wicking material to make direct contact with the or each article to be dried.

Contact between the wicking material and the or each article is preferably achieved by constricting the device, by means of a drawstring or elasticated means as described in relation to the first embodiment. The method may advantageously also include the step of absorbing moisture wicked from the or each article in a further absorptive material.

The invention will be better understood with reference to the following detailed description of two preferred embodiments. Throughout the following description reference is made to a number of accompanying drawings, in which:

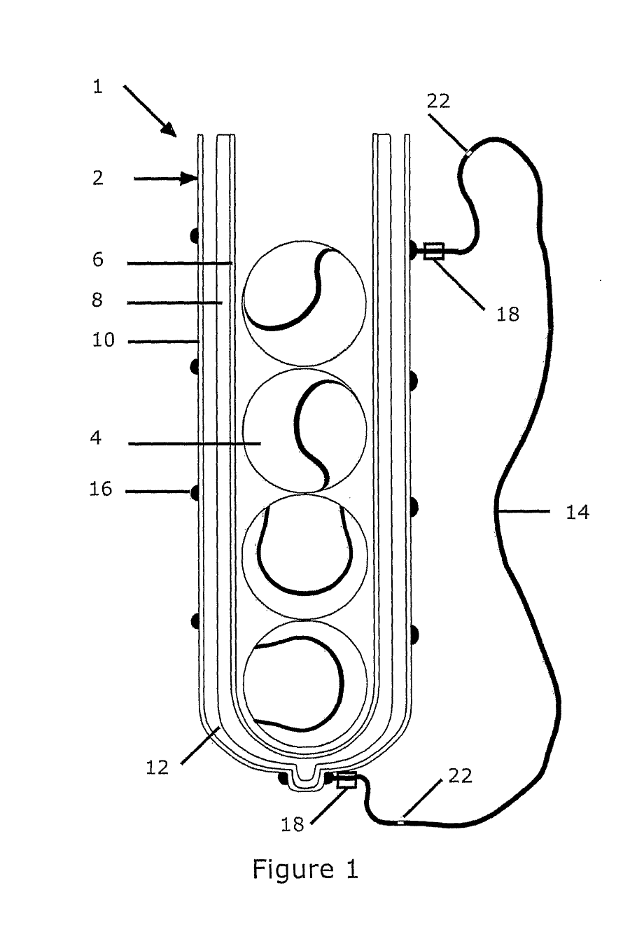

FIG. 1 is a cross-sectional view of a device according to a first aspect of the present invention;

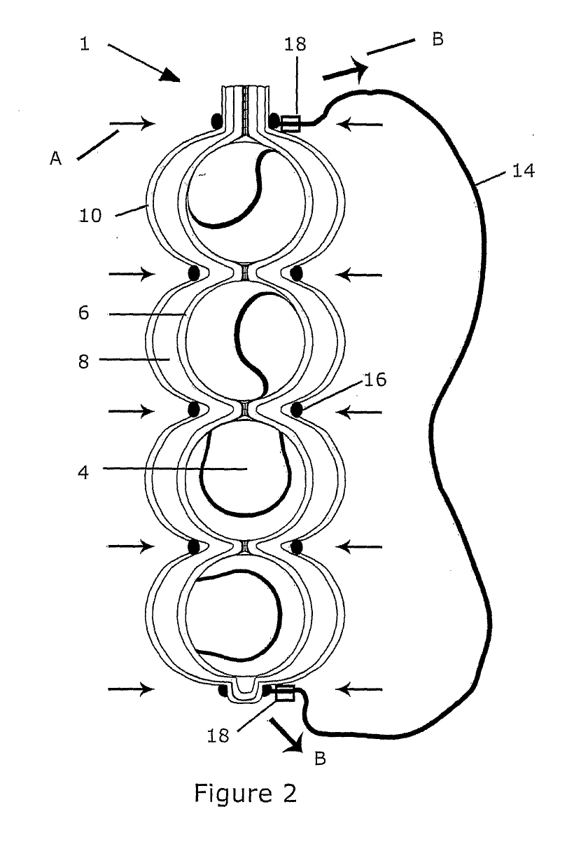

FIG. 2 is a cross-sectional view of the device of FIG. 1 in use;

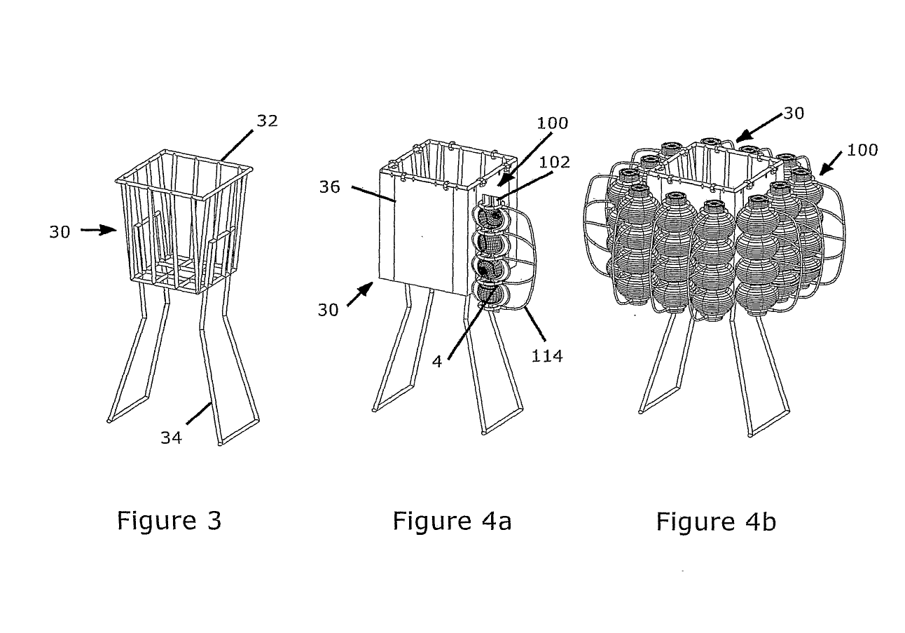

FIG. 3 is a perspective view of a typical tennis coach's ball basket;

FIG. 4a is a perspective view of the ball basket of FIG. 3, showing a cross sectional view of a device according to a second aspect of the present invention; and

FIG. 4b is a perspective view of a ball basket showing a plurality of devices according to a second aspect of the present invention.

The cross-sectional view of FIG. 1 shows a device 1 according to a first aspect of the present invention, containing four tennis balls 4. The device 1 comprises a generally tubular fabric bag 2 made up of three different layers of material. The innermost layer 6 is made from a material with a wicking property, in this case Olifin. The second, intermediate, layer 8 is adjacent the innermost layer and is made of an absorptive cotton material. The third, outermost, layer 10 is made of GORE-TEX® so as to be both weatherproof and breathable. An air gap 12 is provided between the intermediate layer 8 and the outermost layer 10. This allows space for the absorptive intermediate layer 8 to expand when the device 1 is in use.

The device 1 of FIG. 1 also includes a drawstring 14 to close the fabric bag 2. The drawstring 14 runs from the centre of the closed end of the bag 2 to the open end, and is held in place around the bag 2 by a drawstring cover 16. The drawstring cover 16 guides the drawstring 14 around the bag 2 such that a single drawstring 14 can be used to both close the open end of the bag 2, and constrict the bag 2 at a number of other locations to allow it to form around the tennis balls 4. The drawstring 14 is arranged by the drawstring cover 16 to provide a series of loops around the bag 2 at positions which, when the device 1 is in use, will lie between adjacent tennis balls 4. Two draw string fasteners in the form of toggles 18 are provided, one at each end of the drawstring 18. Two marks 20,22 are provided on the drawstring 14 to enable the drawstring 18 to double as a measuring device. A first mark 20 is made on the drawstring 18 close to the closed end of the bag 2, and a second mark 22 is made thirty-six inches (0.914 m) along the drawstring 14 to allow the height of a net to be measured prior to starting a game of tennis. The drawstring 18 also provides a convenient carrying strap for the device 1.

As shown in FIG. 1, four wet tennis balls 4 have just been placed into the device 1 after a session of tennis. The device 1 is operated by tightening the drawstring 14 to cause the bag 2 to constrict around the tennis balls 4 as shown in FIG. 2.

FIG. 2 shows the device 1 in use. The bag 2 has been constricted around the tennis balls 4 by tightening the drawstring 14 by pulling in the direction of arrows B. The open end of the bag 2 has been closed and, due to the guiding of the drawstring 14 by the drawstring cover 16, the bag 2 has been drawn in, as shown by arrows A, to fit the bag 2 tightly around the tennis balls 4. The toggles 18 lock the drawstring 14 in position, which maintains the bag 2 constricted around the tennis balls 4. The tennis balls 4 are contained ready for transport and storage.

It can be clearly seen from FIG. 2 that the innermost layer 6 of Olifin wicking material is formed tightly around each individual tennis ball 4, maximising the contact area between the wicking material and the outer surface of the tennis ball 4. Moisture present in the fibrous covering of each tennis ball 4 is ‘wicked’ through the innermost layer 6 and into the intermediate layer 8 of the device, where it is absorbed and held ready for evaporation. The air gap 12 shown in FIG. 1 has been taken up by the expansion of the absorptive cotton intermediate layer 8 and the constriction of the device 1 in general. The GORE-TEX® outer layer 10 of the bag 2 now provides a substantially enclosed weatherproof cover for the device 1 to protect the tennis balls 4 from the elements. If desired, a further flap (not shown) of GORE-TEX® may be provided to fully enclose the top of the bag 2.

The device 1 shown in FIGS. 1 and 2 is meant for the use of individuals wishing to prolong the useful life of tennis balls. The present invention is, however, also appropriate for use by tennis coaches who wish to dry tennis balls in larger numbers.

FIG. 3 shows a typical tennis coach's basket 30. The basket 30 is used by coaches to hold a large number of tennis balls for ‘feeding’ to a novice or improving tennis player during a coaching session. The basket 30 comprises a container section 32 and two legs 34 to position the basket at an appropriate height for balls to be easily acquired. Commonly, the legs 34 are pivoted to the container 32 so as to double up as a handle for carrying the basket 30 before and after coaching sessions. Coaches will generally also use baskets of this type to store tennis balls between sessions.

Given the large numbers of tennis balls required for an effective coaching session, it is of particular importance to tennis coaches that their tennis balls last as long as possible so as to minimise their costs. It is also particularly important for developing players to be confident of a consistent bounce and flight of a ball when learning the game.

FIG. 4a shows a device 100 according to a second aspect of the present invention attached to a coach's basket 30. A fabric holding belt 36 is attached to the basket 30 to provide somewhere to attach a plurality of drying devices 100. One such device 100 is shown in cross section in FIG. 4a. The device 100 is similar in terms of its layered construction, and general principle of operation, to the device 1 shown in FIGS. 1 and 2. The key differences are as follows. The device 100 for use with a coach's basket 30 comprises a tube 102 of material, as opposed to the bag 2 of the earlier embodiment. The use of a tube 102 allows tennis balls 4 stored in the device to be released either from the top or the bottom of the device 100. The draw string arrangement 114 of the device 100 shown in FIG. 4a also differs from the drawstring 14 of the earlier embodiment. In the device 1 shown in FIGS. 1 and 2 the drawstring 14 is also to be used as a carrying handle and net height measurement device. Accordingly, in the earlier embodiment it is preferable that the drawstring 14 is a single length of cord. The same requirements are not made of the drawstring arrangement 114 of the second embodiment, so the drawstring arrangement 114 is shown connected to the device 100 at each location where the tube of material 102 is to be constricted. This greatly simplifies the constricting of the device 100 and obviates the need for a complex drawstring cover 16, or alternative drawstring guiding means, to guide the drawstring 14 around the device 1 as described in relation to FIGS. 1 and 2.

FIG. 4b shows a possible arrangement of a number of the devices 100 attached to a basket 30. A large number of tennis balls 4 (forty eight as shown) can be stored and dried simultaneously. Alternative arrangements are also envisaged which do not impede the pivoting of the legs 34 of a basket 30 to form handles, where this is a feature of the basket 30 in question.

The forgoing description relates only to preferred embodiments of the present invention, and is not intended to limit the protection sought. Numerous modifications to the system shown are possible. For example, while both embodiments show a device for a standard set of four tennis balls, the device may be adapted to accommodate any number. Variants would preferably be provided for sets of three balls or for multiples of the standard numbers e.g. six, eight or nine balls. The device could be made to conform to the tennis balls by alternative means to a drawstring, for example elasticated sections could be provided. Although the description relates to devices for drying tennis balls, embodiments of the device are also contemplated for drying other sporting goods (balls and otherwise) and wet articles in general.

The materials specified in the detailed description, and those mentioned elsewhere in the document, should be seen only as examples of a far greater number of possible materials which could be used in the device. Any material having the necessary characteristics (wicking, absorption or protection) could be used for the relevant layer. Furthermore, where a particular material encompasses more than one preferable characteristic (e.g. wicking and absorption) this could be used to reduce the total number of layers required in the device.

1. A device for storing and drying one or more articles, the device comprising a layer of a wicking material and means for permitting direct contact of the wicking material with the or each article to be dried.

2. The device according to claim 1, wherein the layer of wicking material is an innermost layer of the device into which, in use, one or more articles are placed.

3. The device according to claim 1, wherein means are provided to constrict the device tightly around the or each article to be dried.

4. The device according to claim 3, wherein the means provided to constrict the device tightly around the or each article comprise a drawstring.

5. The device according to claim 4, further comprising drawstring guiding means.

6. The device according to claim 4, wherein the drawstring comprises a length of webbing material.

7. The device according to claim 4, wherein the drawstring comprises means for measuring a distance.

8. The device according to claim 1, further comprising a layer of absorptive material outside the wicking material to absorb moisture from the or each article being dried.

9. The device according to claim 1, further comprising an outer layer of material which is weatherproof and breathable.

10. The device according to claim 1, wherein the device comprises a fabric bag.

11. The device according to claim 1, wherein the device comprises a tube of fabric.

12. The device according to claim 1, comprising a carrying handle.

13. The device according to claim 1, for storing and drying tennis balls.

14. The device according to claim 13, wherein the device is configured to receive four tennis balls.

15. The device according to claim 13, wherein the device is configured to receive three tennis balls.

16. The device according to claim 13, mounted on a tennis coach's basket.

17. The device according to claim 13, and at least one tennis ball received in the device, wherein the device has an internal diameter substantially equal to the diameter of the at least one tennis ball.

18. A method of storing and drying one or more articles comprising the steps of placing the or each article to be dried into a device comprising a layer of a wicking material, and causing the wicking material to make direct contact with the or each article to be dried.

19. The method according to claim 18, wherein the device is constricted to bring the wicking material into contact with the or each article to be dried

20. The method according to claim 19, wherein the device is constricted using a drawstring.

21. The method according to claim 18, further comprising the step of absorbing moisture from the or each article to be dried using a layer of absorptive material provided in the device.

22. A method of storing and drying one or more tennis balls as described in claim 17.

23-25. (canceled)
